(19) United States
(12) Patent Application Publication
(10) Pub. No.: US 2023/0270057 A1
(43) Pub. Date: Aug. 31, 2023

(54) METHOD AND SYSTEM FOR PREDICTING FRUIT QUALITY

(71) Applicant: Phytech Ltd., Doar-Na Hof Ashkelon (JP)

(72) Inventors: Omer GUY, Kibbutz Kfar Rupin (IL); Oren KIND, Tel Aviv (IL); Ido GARDI, Kfar Haim (IL)

(73) Assignee: Phytech Ltd., Doar-Na Hof Ashkelon (IL)

(21) Appl. No.: 18/015,771

(22) PCT Filed: Jul. 12, 2021
(86) PCT No.: PCT/IL2021/050854

§ 371 Date: Jan. 12, 2023

Related U.S. Application Data
(60) Provisional application No. 63/050,808, filed on Jul. 12, 2020.

(51) Int. Cl. A01G 17/00; A01G 22/05; G06Q 50/02

(52) U.S. Cl. CPC A01G 17/005; A01G 22/05; G06Q 50/02

(57) ABSTRACT

A method of predicting fruit quality in a crop before harvesting the crop, comprises receiving a fruit quality threshold for the crop, and selecting a sub-seasonal time-window and a growth threshold, based on the fruit quality threshold. The method also comprises monitoring growth of the crop before a beginning of the time-window, and continuing the monitoring throughout the time-window. If the monitored growth is below the growth threshold during at least 80% of the time-window, then the method provides a prediction output that the fruit quality is above the fruit quality threshold for at least a first percentage of the crop.

### RELATED APPLICATION

This application claims the benefit of priority of U.S. Provisional Patent Application No. 63/050,808 filed on Jul. 12, 2020, the contents of which are incorporated herein by reference in their entirety.

### FIELD AND BACKGROUND OF THE INVENTION

The present invention, in some embodiments thereof, relates to agriculture and, more particularly, but not exclusively, to a method and system for predicting and optionally and preferably controlling fruit crop quality.

In recent years, along with the globalization of international market, the quality of a foodstuff is a primary factor in a consumer's purchasing decision. Various properties and characteristics of the foodstuff are considered by the purchaser. For example, freshness, juiciness, firmness, appearance, and other parameters are evaluated. These and other properties and characteristics are considered in the purchase decision.

In particular, consumers evaluate vegetables and fruits by visual, manual, and sometimes taste testing. In recent years, along with the globalization of international market, people require also more and more higher to fruit quality. Taste characteristics are a major determinant of fruit quality for both processing and fresh market fruits. One of the major components of taste in fruits is soluble sugar content. Typically, plant breeders seek to improve the sweetness component of the fruit by increasing total soluble solids (TSS) expressed as Brix (° Bx).

Brix is typically measured post-harvesting by examining the refractive index of the fruit's juice, or by estimating the apparent specific gravity thereof.

### SUMMARY OF THE INVENTION

According to some embodiments of the invention the present invention there is provided a method of predicting fruit quality in a crop before harvesting the crop. The method comprises: receiving a fruit quality threshold for the crop; selecting a sub-seasonal time-window and a growth threshold, based on the fruit quality threshold. The method also comprises monitoring growth of the crop before a beginning of the time-window, and continuing the monitoring throughout the time-window. If the monitored growth is below the growth threshold during at least 80% of the time-window, then the method provides a prediction output that the fruit quality is above the fruit quality threshold for at least a first percentage of the crop. In some embodiments of the present invention if the monitored growth is not below the growth threshold during at least 80% of the time-window, then the method provides a prediction output that the fruit quality is above the fruit quality threshold for less than the first percentage of the crop.

According to some embodiments of the invention, the method comprises restraining a growth of the crop if the monitored growth is not below the growth threshold.

According to some embodiments of the invention, the method comprises terminating the restraining of the growth of the crop when the monitored growth is below the growth threshold.

According to some embodiments of the invention, if the restraining of the growth of the crop is within the time-window, then predicting a fruit quality which is above than the fruit quality threshold for at most a second predetermined percentage of the crop, the second percentage being not higher than the first percentage.

According to some embodiments of the invention the growth is restrained by reducing or terminating irrigation. According to some embodiments of the invention the growth is restrained by reducing or terminating fertilization.

According to some embodiments of the invention the growth is monitored by monitoring a width of a trunk of a fruit tree.

According to some embodiments of the invention the fruit quality comprises level of total soluble solids.

According to some embodiments of the invention the crop is a citrus crop. According to some embodiments of the invention the crop is an orange crop.

According to some embodiments of the invention the crop is a grape crop.

According to some embodiments of the invention the crop is a tomato crop.

According to some embodiments of the invention the crop is a stone fruit crop. According to some embodiments of the invention the crop is a plum crop. According to some embodiments of the invention the crop is a peach crop.

According to an aspect of some embodiments of the present invention there is provided a computer software product. The computer software product comprises a non-transitory computer-readable medium in which program instructions are stored, which instructions, when read by a data processor, cause the data processor to receive receiving a sub-seasonal time-window, a growth threshold, a fruit quality threshold, and monitored values of growth of a crop before a beginning of the time-window, and the execute the method as delineated above and optionally and preferably as further detailed below.

According to an aspect of some embodiments of the present invention there is provided a system for predicting fruit quality in a crop before harvesting the crop. The system comprises: a data processor configured for receiving a fruit quality threshold for the crop, for selecting a sub-seasonal time-window and a growth threshold, based on the fruit quality threshold, and for predicting a fruit quality which is above the fruit quality threshold for at least a first percentage of the crop if the monitored growth is below the growth threshold during at least 80% of the time-window. According to some embodiments of the present invention the system also comprises a sensor system deployed and configured for measuring and transmitting data pertaining to a growth the crop.

According to some embodiments of the invention the data processor is configured for generating output instructing to restrain a growth of the crop if the monitored growth is not below the growth threshold.

According to some embodiments of the invention the data processor is configured for generating output instructing to terminate the restraining of the growth of the crop when the monitored growth is below the growth threshold.

According to some embodiments of the invention the data processor is configured for predicting a fruit quality which is above than the fruit quality threshold for at most a second predetermined percentage of the crop, if the restraining of the growth of the crop is within the time-window, the second percentage being not higher than the first percentage.

According to some embodiments of the invention the sensor system is configured for monitoring a width of a trunk of a fruit tree.

According to some embodiments of the invention the fruit quality comprises level of total soluble solids.

According to some embodiments of the invention the crop is a citrus crop.

According to some embodiments of the invention the crop is a citrus crop.

According to some embodiments of the invention the fruit quality threshold equals at least 10° Bx, and the first percentage equals at least 50%.

According to some embodiments of the invention a duration of the time-window is at least one month but less than three months.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram of a method suitable for predicting, and optionally and preferably controlling, fruit quality in a crop before harvesting the crop according to embodiments of the present invention;

FIG. 2 is a schematic illustration showing a block diagram of a system for predicting fruit quality, and optionally and preferably also for controlling fruit quality, in a crop before harvesting the crop, according to some embodiments of the present invention;

FIG. 3 is a histogram of average monthly trunk growth, in microns, of orange trees for high Brix plots and control plots, as measured in experiments performed according to some embodiments of the present invention;

FIG. 4 is a histogram of average monthly trunk growth, in microns, of orange trees for four different values of Brix, as measured in experiments performed according to some embodiments of the present invention;

FIG. 5 is a histogram of monthly growth, in microns, of grape vines, and corresponding brix levels in ° Bx, as measured in experiments performed according to some embodiments of the present invention;

FIG. 6 shows change in brix levels during a veraison period of grapes, as a function of trunk growth in microns, as measured in experiments performed according to some embodiments of the present invention;

FIG. 7 is a histogram of monthly growth, in microns, of peach trees, and corresponding brix levels in ° Bx, as measured in experiments performed according to some embodiments of the present invention;

FIG. 8 is a histogram of monthly growth, in microns, of Candy Princess peach trees, and corresponding brix levels in ° Bx, as measured in experiments performed according to some embodiments of the present invention;

FIG. 9 is a histogram of monthly growth, in microns, of Polar Princess peach trees, and corresponding brix levels in ° Bx, as measured in experiments performed according to some embodiments of the present invention;

FIG. 10 is a histogram of a two-month additive growth, in microns, of prune orchid trees, and corresponding brix levels in ° Bx, as measured in experiments performed according to some embodiments of the present invention;

FIG. 11 is a histogram of monthly growth, in microns, of open field tomato plants, and corresponding brix levels in ° Bx, as measured in experiments performed according to some embodiments of the present invention;

FIG. 12 is a histogram of average Brix level of pears as a function of aggregated trunk growth, obtained in experiments performed according to some embodiments of the present invention;

FIG. 13 is a histogram of Brix level of Gala apples as a function of monthly trunk growth, obtained in experiments performed according to some embodiments of the present invention;

FIG. 14 is a histogram of Brix level of Pink Lady apples as a function of monthly trunk growth, obtained in experiments performed according to some embodiments of the present invention; and

FIG. 15 is a histogram of average Brix level of Clementine mandarins as a function of trunk growth, obtained in experiments performed according to some embodiments of the present invention;

### DESCRIPTION OF SPECIFIC EMBODIMENTS OF THE INVENTION

The present invention, in some embodiments thereof, relates to agriculture and, more particularly, but not exclusively, to a method and system for predicting and optionally and preferably controlling fruit crop quality.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

In a search for a technique that predicts, and optionally and preferably also increases, the quality of fruit crop ahead of harvesting, the Inventors unexpectedly discovered that the quality of the fruit after harvesting depends on the characteristic of the plant (e.g., tree) carrying the fruit, during a relatively short, sub-seasonal, time-window. Specifically, the Inventors discovered a negative correlation between the growth of the plant during the time-window and the quality of the fruit after harvesting. The Inventors have therefore postulated that the growth of the plant and the quality of its fruits both compete for the same energy resources, particularly carbon allocation, wherein higher amount of carbon that is allocated, e.g., to growth of trunk, canopy and roots, reduces the amount of carbon that is allocated to build up the fruit quality (e.g., production of soluble sugars, such as glucose, sucrose, and fructose) and vice versa.

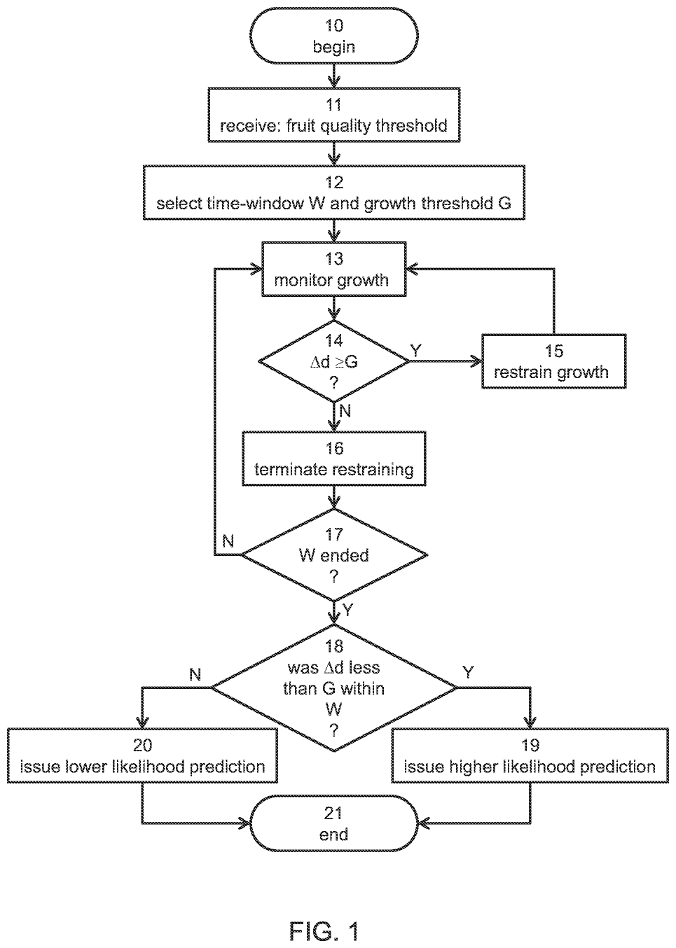

Referring now to the drawings, FIG. 1 is a flowchart diagram of a method suitable for predicting, and optionally and preferably controlling, fruit quality in a crop before harvesting the crop according to various exemplary embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

At least part of the operations described herein can be implemented by a data processing system, e.g., a dedicated circuitry or a general purpose computer, configured for receiving data and executing the operations described below. At least part of the operations can be implemented by a cloud-computing facility at a remote location. One or more of the operations described below can be implemented by a data processor of a mobile device, such as, but not limited to, a smartphone, a tablet, a smartwatch and the like, supplemented by software app programed to receive data and execute processing operations.

Computer programs implementing the method can commonly be distributed to users on a distribution medium such as, but not limited to, a flash memory, CD-ROM, or a remote medium communicating with a local computer over the internet. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method. All these operations are well-known to those skilled in the art of computer systems.

The method can be embodied in many forms. For example, it can be embodied on a tangible medium such as a computer for performing the method steps. It can be embodied on a computer readable medium, comprising computer readable instructions for carrying out the method steps. In can also be embodied in electronic device having digital computer capabilities arranged to run the computer program on the tangible medium or execute the instruction on a computer readable medium.

The method is based on the Inventors' observation that a sufficiently small growth of the plant during a selected time-window is indicative that the fruit quality after harvest will be high for a large portion of the crop, since during the selected time-window energy resources were shifted from the plant's growth to an increase in the quality of the fruit. The Inventors have tailored this understanding to a method in which the fruit quality can be predicted and optionally and preferably also controlled. The method can predict the fruit quality for many type of fruit crops, including, without limitation, citrus (e.g., orange, tangerine, clementine, lemon, lime), apple, pear, plum, cherry, guava, peach, nectarine, apricot, loquat, mango, watermelon, melon, kiwi, papaya, coffee, pepper, and tomato.

In some preferred embodiments of the present invention the method predicts the fruit quality for a citrus crop, e.g., a crop of oranges or clementine or clementine mandarins. In some preferred embodiments of the present invention the method predicts the fruit quality for a stone fruit crop. In some preferred embodiments of the present invention the method predicts the fruit quality for grape crop. In some preferred embodiments of the present invention the method predicts the fruit quality for tomato crop. In some preferred embodiments of the present invention the method predicts the fruit quality for pear crop. In some preferred embodiments of the present invention the method predicts the fruit quality for apple crop.

The fruit quality predicted and optionally and preferably also controlled by the method is typically expressed in terms of plant-produced substances, such as, but not limited to, total soluble solids, such as sugars, oil content, and the like.

The method preferably predicts the utility before harvest.

The method thus begins at 10 and continues to 11 at which a fruit quality threshold is received as an input parameter for the specific crop under analysis. The fruit quality threshold is typically a minimal fruit quality which is desired for the specific crop under analysis. In some embodiments of the present invention the fruit quality threshold is a level of total soluble solids, typically a desired minimal level of total soluble solids. In these embodiments the fruit quality threshold can be expressed as a Brix level (° Bx). For example, when the crop is a citrus crop (such as, but not limited to, an orange crop), the fruit quality threshold can be at least 10° Bx, more preferably at least 11° Bx, e.g., 12° Bx or more. The input parameter can be received using a user interface of a computer or a mobile device, or they can be read from a computer readable storage medium, or transmitted by a remote computer over a communication network such as the internet.

The method can receive the fruit quality threshold itself or some proxy thereof. For example, the present embodiments also contemplate a situation in which the fruit quality threshold is inferred from the type of the crop, and the method receives the type of crop and infers the fruit quality threshold, e.g., using a lookup table that has been prepared in advance and that associates crop types with fruit quality thresholds.

The method optionally and preferably continues to 12 at which a time-window, preferably a sub-seasonal time-window W, and a growth threshold G are selected based on the fruit quality threshold and the specific crop under analysis. The time-window W and the growth threshold G can be obtained from the aforementioned lookup table, which lookup table can include a plurality of entries each including a time-window, a growth threshold, a fruit quality threshold, and a fruit type or a fruit genus.

A typical duration of the input time-window W is from about one month to about two months. In some embodiments of the present invention the time-window W and the growth threshold G are selected in mutual-correlation. Thus, for larger growth threshold the method optionally and preferably selects a longer time window, and vice versa. In some embodiments of the present invention the beginning and end of the time window are within the season preceding the harvesting season of the fruit under analysis. For example, when the crop includes fruits to be harvest at winter time, the time-window W can span over a one or two months during the autumn preceding said winter.

The growth threshold G enacts a comparison parameter that allows the method to determine, quantitatively, whether or not the growth during the time-window W was sufficiently small, as will be explained below. The growth threshold G can be provided in nominal values for the entire time-window W (for example, G mm of growth from the beginning to the end of the time window W), or as a nominal growth rate (for example, G mm per unit time, e.g., per month), or it can be provided in relative values (for example, G % of growth from the beginning to the end of the time window W), or as a relative growth rate (for example, G % of growth per unit time, e.g., per month). The growth rate optionally and preferably corresponds to the phrenological season stage that encompasses the time-window. As a representative and non-limiting example, the growth threshold G can be from about 300 μm to about 800 μm, e.g., about 400 μm.

It is appreciated that the preferred duration of the time-window, the preferred growth threshold G, and the preferred beginning of the time-window, depends on the type of the fruit as well as on the hemisphere on which it is grown. Table 1, below, provides representative and non-limiting examples for preferred time-windows and growth thresholds, for several fruit types.

TABLE 1

| | | W | | |
|---|---|---|---|---|
| | | Beginning | Duration | G |
| Fruit Type | Hemisphere | [Day Of Year] | [Days] | [μm] |
| Orange | North | 240-250 | 25-35 | 110-130 |
| Orange | South | 55-65 | 25-35 | 140-160 |
| Mandarin | North | 240-250 | 25-35 | 210-230 |
| Grapes | South | 330-365 | 25-35 | 1300-1500 |
| Grapes | North | 175-190 | 25-35 | 1100-1300 |

At 13 the growth Δd of the plants in the crop's field is monitored. The monitoring preferably starts before (e.g., about a week before) the beginning of the input time-window, and continues throughout the time-window. Preferably, the monitoring begins at the beginning of the season (e.g., spring) encompassing the time-window.

The monitoring is preferably continuous at a sampling rate that is sufficiently high to allow monitoring variations in the growth across different periods of the day. Typically, but not obligatorily, the measurements are obtained at least once a month, or at least every two weeks, or at least every week, or at least once a day, or at least every 12 hours, or at least every 6 hours, or at least every 4 hours, or at least every 2 hours, or at least every 1 hour, or at least every 30 minutes, or at least every 15 minutes.

Preferably the growth Δd is monitored using data received from a sensor system deployed and configured for measuring the size of the plants and transmitting data or signals indicative of the measured size. In some embodiments of the present invention the measured size is a diameter of the plant's trunk. In various exemplary embodiments of the invention the deployed sensor system comprises one or more dendrometers.

A dendrometer is a known device, which typically comprises a transducer member which is capable of mechanically flexing in response to changes in plant stem or trunk size. The transducer member can include strain gauges, such as, but not limited to, electronic strain gauges, attached thereto in a configuration which allows flexing of the transducer member to be measured as the level of strain in the attached strain gauges vary.

A dendrometer useful for the present embodiment can optionally include elongated jaws connected to the transducer member for engaging the plant part. The jaws are preferably designed to cause minimum destruction and deformation of the plant stem tissue. The dendrometer can, for example, use single C-shaped, plastic or other noncorrodible and temperature staple transducer members. The dendrometer can alternatively include arms which can be hinged together and connected by a transducer member which experiences strain as a result of size changes of stems engaged between the hinged arms or elongated jaws attached or integral therewith. Further alternative forms of the dendrometer can utilize a pair of hinged plates which contact the plant stem or trunk. Inn these embodiments the transducer member extends between the pair of hinged plates and experiences measurable strain due to changes in the stem or trunk size. Other types of dendrometers are also contemplated in some embodiments of the present invention. Other types of sensors are also contemplated. Representative examples including, without limitation, a pressure chamber, a psychrometer and/or a temperature sensor.

The method optionally and preferably proceeds to decision 14 at which the method determines if the monitored growth Δd is above or equal to the growth threshold G. If the monitored growth Δd is above or equal to the growth threshold G, the method preferably proceeds to 15 at which the growth of the crop is restrained. This can be done, for example, by reducing or terminating irrigation, or by reducing or terminating fertilization, or by any technique known in the art for restraining the growth of a plant, including the use of growth regulator. From 15 the method loops back to 13 and continues the monitoring. If the monitored growth Δd is less than the growth threshold G, the method preferably proceeds to 16 at which the restraining (if applied) is terminated. If no restraining is applied, the method skips 16. The method preferably proceeds to decision 17 at which the method determine if the time-window W is ended. If time-window W is not ended, the method loops back to 13 and continues the monitoring.

If time-window W is ended, the method proceeds to decision 18. In the schematic illustration of FIG. 1, decision 18 is shown as a binary decision, but more than two types of outcomes for decision 18 are also contemplated, as will now be explained.

At 18 the method generally determines whether the monitored growth was sufficiently small over a sufficiently long portion of the time-window. In the simplest embodiments, the method determines whether the growth Δd was less than the growth threshold G, over, e.g., at least 80% or at least 90% of the time-window, or throughout the time-window. In these embodiments, it sufficient to employ a counting protocol wherein a counter stored in the memory of the computer is updated each time the condition at 14 is met within the time-window, in which case the method can base the determination at 18 using the value of the counter. Alternatively, the method can maintain a time-ordered log of the monitored values of the growth Δd and analyze the log over the time span of the window W. For example, the method can weigh the time periods within W during which Δd was small (e.g., less than G), e.g., by assigning higher weight for longer time periods and lower weight for shorter time periods, wherein the outcome of decision 18 corresponds to the aggregated weight. In this case, decision 18 can have more than two possible outcomes, depending on the value of the aggregated weight.

Based on the outcome of decision 18 the method selects a prediction for the fruit quality (e.g., a prediction pertaining to the total soluble solids, for example, Brix level). In various exemplary embodiments of the invention the selected perdition relates to the input fruit quality threshold. The difference between the predictions is in the relative frequency of the predicted fruit quality.

Consider, for example, a case in which the method determines (in a binary or non-binary decision) that monitored growth was sufficiently small over a sufficiently long portion of the time-window. According to the observation made by the Inventors, this indicates that a larger portion of the energy resources were invested by the plant on building fruit quality (e.g., generating total soluble solids, such as sugars), and a smaller portion of the energy resources was spent on growth. Thus, in this case the method optionally and preferably issues a higher likelihood prediction (shown at 19, for the binary case) in which the fruit quality is predicted to be above the fruit quality threshold for a high fraction of the crop. For example, the higher likelihood prediction can indicate that the fruit quality is predicted to be above the fruit quality threshold for at least P₁% of the crop, where P₁ is a preselected relative frequency parameter, such as, but not limited to, 50 or 60 or 70 or 80 or more.

Now, consider an opposite case in which the monitored growth was sufficiently small over an insufficient portion of the time-window, indicating that more energy resources were invested by the plant on growth and less resources were used for building fruit quality (e.g., generating total soluble solids, such as sugars). In this case the method optionally and preferably issues a lower likelihood prediction (shown at 20, for the binary case) in which the fruit quality is predicted to be above the fruit quality threshold for a smaller fraction of the crop. For example, the second prediction can indicate that the predicted fruit quality is above the fruit quality threshold for at most P₂% of the crop, where P₂ is a preselected relative frequency parameter satisfying P₂≤P₁.

In principle, there can be a plurality of different values for the relative frequency parameter, e.g., P₁, P₂, . . . , P_{N}, with P₁≥P₂ . . . ≥P_{N}, and the method can generally issue one of N types of predictions, wherein each of the N types of prediction includes a different value for the relative frequency parameter, and wherein the relative frequency parameter is selected based on the on the analysis of the time-ordered log of the monitored values of the growth Δd (e.g., based on the aggregated value of the aforementioned weight) as further detailed hereinabove.

Both in the binary decision case and in the non-binary decision case, the relative frequency parameters P₁, P₂, etc., can be obtained from the aforementioned lookup table. In these embodiments each entry of the lookup table also includes one or more relative frequency parameters that indicate the predicted fraction of the crop for which the fruit quality is above the threshold.

In some embodiments of the present invention the method also obtain data pertaining to the size of the fruit and uses these data, for example, to determine whether or not to continue the monitoring and/or the irrigation. For example, when the fruit size is below a predetermined threshold the method can terminate all operations.

The method ends at 21.

The method can, as stated, be implemented by a data processor. The data processor can be a server at a remote location, and data pertaining to the monitored growth Δd can be transmitted to the remote server. The server can issue instructions and prediction to a local processor or controller. For example, instructions to execute operations 15 and 16 can be transmitted by the server to a controller that controls an irrigation and/or fertilization and/or growth regulating system, so that the growth can be restrained 15 and unrestrained 16 automatically, without human intervention. The server can also transmit instructions to a mobile device held by or positioned nearby the local grower, to display on a user interface of the mobile device recommendations to execute operations 15 and 16. The mobile device can be any of a variety of computing devices (e.g., cell phone, smartphone, handheld computer, laptop computer, notebook computer, tablet device, notebook, media player, Personal Digital Assistant (PDA), camera, video camera, or the like). In various exemplary embodiments of the invention the mobile device is a smart phone. The mobile device can also be used by the server to display the prediction, in which case the server optionally and preferably executes the decision 18, select the prediction based on the outcome of decision 18 as further detailed hereinabove and transmits the selected prediction to the mobile device for displaying the prediction on the user interface thereof.

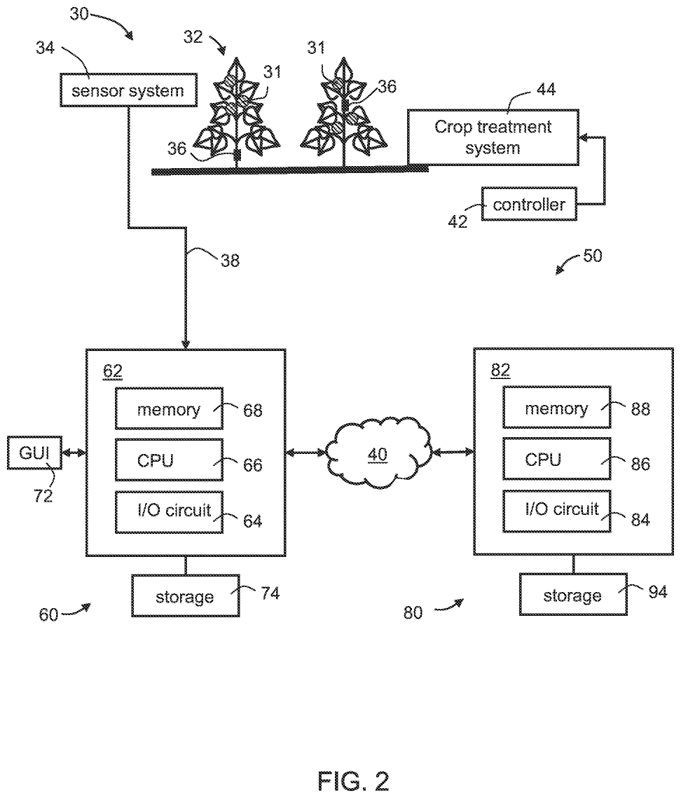

FIG. 2 is a schematic illustration showing a block diagram of a system 30 for predicting fruit quality, and optionally and preferably also for controlling fruit quality, in a crop 32 having fruits 31 before harvesting the crop, according to some embodiments of the present invention.

System 30 comprises a sensor system deployed and configured for measuring and transmitting data pertaining to a growth the crop. Sensor system is designated by block 34, but represents also embodiments in which the sensor system includes a plurality of sensing elements arranged for measuring the growth for each of at least a portion of the plants of crop 32. Representative examples of such sensing elements are shown at 36. The sensing elements are optionally and preferably attached to a part of plant, preferably to the truck of the plant, as illustrated in FIG. 2. In various exemplary embodiments of the invention the sensor system comprises at least one dendrometer. In some embodiments of the present invention the sensor system also comprises one or more sensing elements that measure the size of the fruits 31.

Sensor system 34 can transmit the measured data over a dedicated communication channel 38 which can be a wired communication channel or a wireless communication channel as desired. Alternatively, system 34 can transmit the measured data over a communication network 40, such as a local area network (LAN), a wide area network (WAN) or the Internet.

System 30 optionally and preferably comprises a computing platform 50 which is configured to receive the data from the sensor system, and execute at least some of the operations described above with respect to method 10. Optionally, system 30 also comprises a controller 42 which communicates with computing platform 50 (over the dedicated communication channel 38 or the communication network 40) and is configured for operating a crop treatment system 44 responsively to instructions transmitted by computing platform 50 as further detailed hereinabove. In some embodiments of the present invention system 30 also comprises the crop treatment system 44.

Shown in FIG. 2 is a computing platform that includes a client-server configuration having a client computer 60 and a server computer 80. However, this need not necessarily be the case, since, for some applications, it may not be necessary for system 30 to include a client-server configuration. For example, system 30 can include only one of the computers.

Client computer 60 has a hardware processor 62, which typically comprises an input/output (I/O) circuit 64, a hardware central processing unit (CPU) 66 (e.g., a hardware microprocessor), and a hardware memory 68 which typically includes both volatile memory and non-volatile memory. CPU 66 is in communication with I/O circuit 64 and memory 68. Client computer 60 preferably comprises a user interface, e.g., a graphical user interface (GUI), 72 in communication with processor 62. I/O circuit 64 preferably communicates information in appropriately structured form to and from GUI 72.

Server computer 80 can similarly include a hardware processor 52, an I/O circuit 84, a hardware CPU 86, and a hardware memory 88. I/O circuits 64 and 84 of client 60 and server 80 computers preferable operate as transceivers that communicate information with each other via a wired or wireless communication. For example, client 60 and server 80 computers can communicate via network 40. Server computer 80 can be in some embodiments be a part of a cloud computing resource of a cloud computing facility in communication with client computer 60 over the network 40.

GUI 72 and processor 62 can be integrated together within the same housing or they can be separate units communicating with each other. GUI 72 can optionally and preferably be part of a system including a dedicated CPU and I/O circuits (not shown) to allow GUI 72 to communicate with processor 62. Processor 62 issues to GUI 72 graphical and textual output generated by CPU 66. Processor 62 also receives from GUI 72 signals pertaining to control commands generated by GUI 72 in response to user input. GUI 72 can be of any type known in the art, such as, but not limited to, a keyboard and a display, a touch screen, and the like. In preferred embodiments, GUI 72 is a GUI of a mobile device such as a smartphone, a tablet, a smartwatch and the like. When GUI 72 is a GUI of a mobile device, the CPU circuit of the mobile device can serve as processor 62 and can execute the method of the present embodiments by executing code instructions.

Client 60 and server 80 computers can further comprise one or more computer-readable storage media 74, 94, respectively. Media 74 and 94 are preferably non-transitory storage media storing computer code instructions for executing the method of the present embodiments, and processors 62 and 82 execute these code instructions. The code instructions can be run by loading the respective code instructions into the respective execution memories 68 and 88 of the respective processors 62 and 82. One or both storage media 74 preferably also store one or more lookup tables including time-windows and growth thresholds associated with various crop types and fruit quality thresholds, and optionally and preferably also relative frequency parameters as further detailed hereinabove.

In operation, processor 62 of client computer 60 receives from GUI 72 characteristic information pertaining to the crop to be analyzed. Such information can include the field of the grower from which data are to be collected, the type of crop that is grown in the field, and optionally also the desired fruit quality. The sensor system that is deployed in the respective field transmits to processor 62 of client computer 60 signals pertaining to the monitored growth Δd. Processor 62 preferably transmits the monitored growth and the characteristic information received by GUI 72 server computer 80 over network 40. Media 94 can store the aforementioned lookup table, and processor 82 can access media 94 and use the lookup table for selecting the sub-seasonal time-window and growth threshold, as further detailed hereinabove. Media 94 can also store computer code instructions for predicting the fruit quality as further detailed hereinabove, and optionally and preferably for generating output instructions to restrain and terminate the restraining of the growth, which output instructions can be transmitted directly to controller 42 or to client computer 60 for transmitting them to controller 42 or displaying them on GUI 72. At the end of the time-window, server computer 80 can transmit to client computer 60 the selected prediction, and client computer 60 can display this prediction on GUI 72.

When computing platform includes a single computer, the above operations are all executed by the same computer. In these embodiments, the same computer that receives the data from the sensor system also selects the sub-seasonal time-window and growth threshold, predicts the fruit quality, and optionally generate output instructions to restrain and terminate the restraining of the growth. For example, system 30 can includes only computer 60, in which case the lookup table and the computer code instructions can be stored in media 74.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Over the years, several attempts have been made to increase brix, particularly in crops such as wine grapes and citrus. These include fertilization (Dichio, Xiloyannis, Sofo, & Montanaro, 2007; GI Moss, 1974), spray of growth regulators (Agustí, Martinez-Fuentes, & Mesejo, 2002; Goldschmidt, 1999) or deficit irrigation.

In tomatoes, it was found that imposing water stress or irrigation with saline water could increase brix levels, through the reduction of water accumulation in the fruits (Grattan, 1991). However, there was no association to the time window during which the water stress should be imposed, since it was not realized that water stress induce diversion of the energy resources from growth to production of sugars in the fruit. In wine grapes defecate irrigation was shown to improve the quality of the fruits through an increase in sunlight exposure. However, negative correlation to the size of the grape was found (Mccarthy, Cirami, & Mccloud, 2017; Serman et al., 2004). The respond of citrus trees to water stress has been found to be deeply depended in the phenological stage of the tree and the climatic conditions (Ballester, Intrigliolo, National, & Castel, 2013).

In a recent study, it was found that applying water stress in the fruit growth period resulted in decreasing in fruit diameter and increase of fruit drop (Castel, 2015). Other studies found that later stress does not change the yield, and may affect the ripping duration (Tejero et al., 2011), without increasing the brix level (Gam, Romero, Muriel, & Capote, 2012).

Following is a description of experiments in which high-resolution dendrometers were used to monitor on-line trunk growth. Restraining the trunk growth successfully shifted the carbon allocation in favor of the fruits, over vegetative growth, resulting in increase of fruit brix. Once the trunk growth rate has been restrained to below a growth threshold, irrigation was resumed to normal amounts.

Fruit size sensors were employed to make sure that during the experiments, the fruit size keeps on track to predefined size on a predefined date. In accordance with some embodiments of the present invention, the experiments employed continuous measurement, assisting in determining the timing and magnitude of required intervention in order to achieve optimal fruit size, yield, and brix, and prevented exaggerated stress, so as not to reduce the fruit size and/or reduce yield potential next growing season.

### Example 1

### Oranges

### Methods

Large Scale Analysis

Daily trunk growth data was measured in 450 commercial plots of navel oranges during the seasons of 2018 in California USA. In each plot, an NDVI map (10 m² pixel area) was used in order to select location with common vegetation cover. In each location, three trees of representative dimensions were selected and high resolution dendrometer were installed on their trunks, above the grafting level.

Random Fruit Sampling

Four navel plots in the same orchid in California southern valley were selected. Similar location selection and installation setup as described in the large scale analysis section was performed. Brix levels were measured from randomly selected fruits, at the end of October, using an ATAGO pocket refractometer (0-53%).

### Results

Large Scale Analysis

Based on packinghouse results, 214 plots reached brix score of 12% (12° Bx) and above.

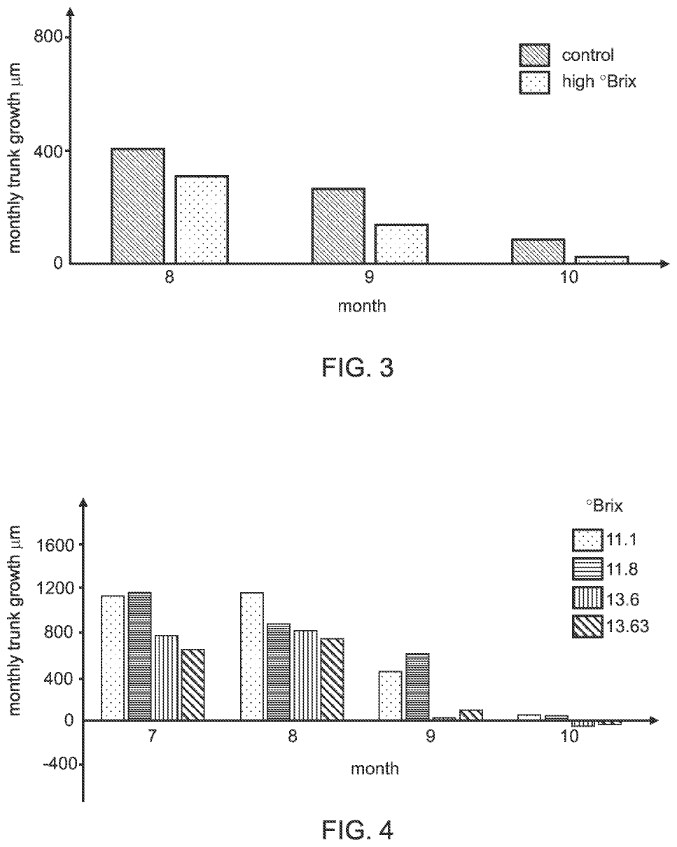

FIG. 3 shows a histogram of the average monthly trunk growth as measured during August, September and October for the 214 plots scored with high brix and the other 233 plots which served as control. During August and September, the average trunk growth of the high brix plots was less than control by at least 100 microns. These results verifies the Inventors postulation that reduction in vegetative growth during a time window with a season preceding the harvest enforces a shift in the tree carbon investment towards reproduction and fruits on the account of the canopy and roots.

Random Fruit Sampling

FIG. 4 shows a histogram of the average monthly trunk growth for four different values of Brix. The results support the Inventors observation of a significant negative correlation between the monthly growth during the selected time window and the Brix level.

### Example 2

### Grapes

Trunk growth of 25 samples of grape vines in Victoria, Australia was monitored in accordance with some embodiments of the present invention. The vines included wine grapes and table grapes, and the monitoring was over a period of two-months (November and December). Brix level of fruits of specific monitored vines was measured using portable refractometer (Atago, Japan).

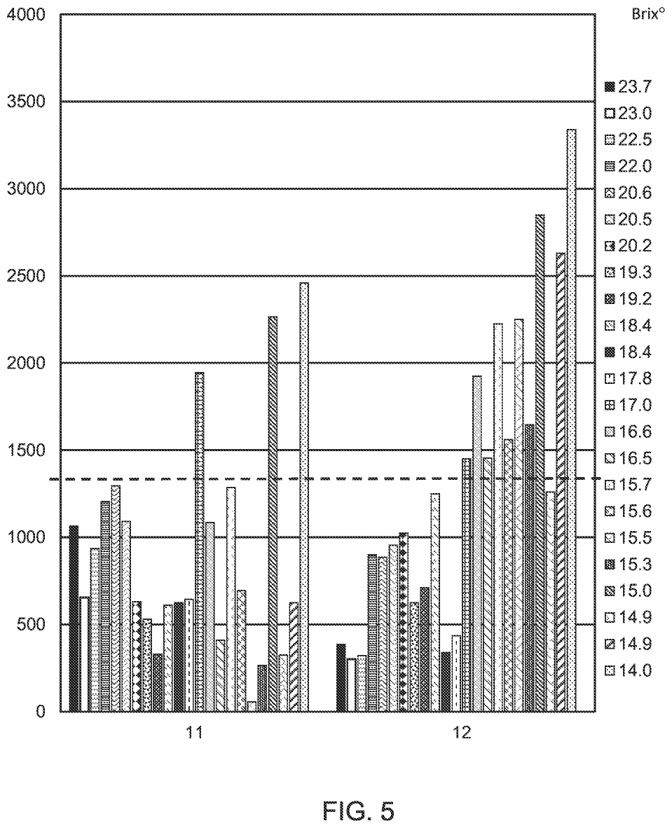

FIG. 5 shows the monthly growth of the vines in microns. The dash line represents a monthly growth threshold G of about 1300 μm. As shown, high brix levels of more than about 15° Bx were obtained for vines for which the monthly growth during December was maintained below the growth threshold.

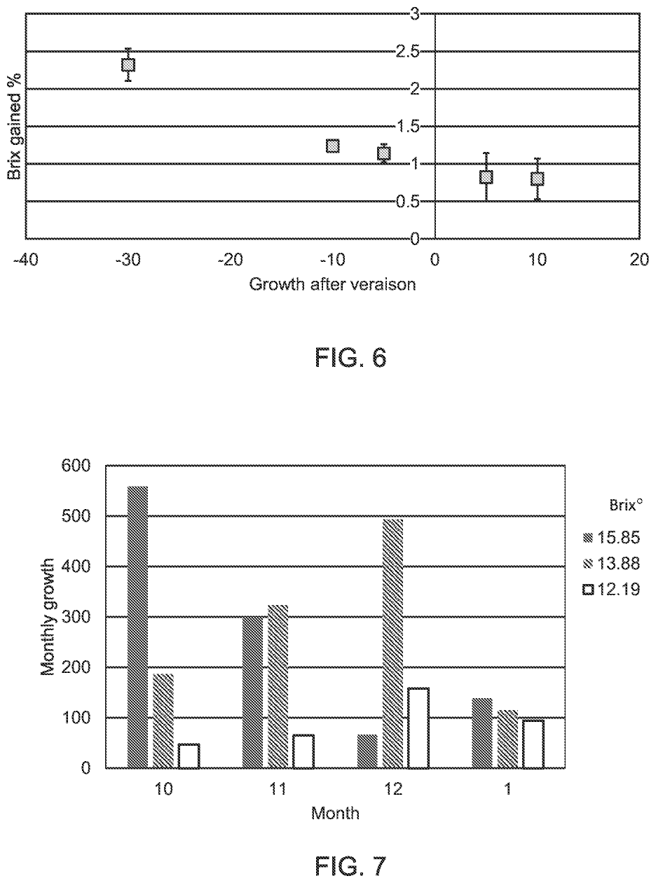

For 9 samples of grape vines, brix was measured using portable refractometer (Atago, Japan) every 1 to 7 days. FIG. 6 shows the change in brix levels during the veraison period until harvest, as a function of trunk growth in microns during this time. The accumulation of sugars in the grape (brix level) shows negative correlation to the trunk growth.

### Example 3

### Stone Fruits

Trunk growth of 9 samples of early harvest peach trees in a plot in Victoria, Australia was monitored in accordance with some embodiments of the present invention. Brix was measurements were obtained from processing factory or packing house of fruits collected from the plot.

FIG. 7 shows the monthly growth, in microns, of the monitored peach trees. As shown, the brix level is negatively correlated to the growth during the month of December.

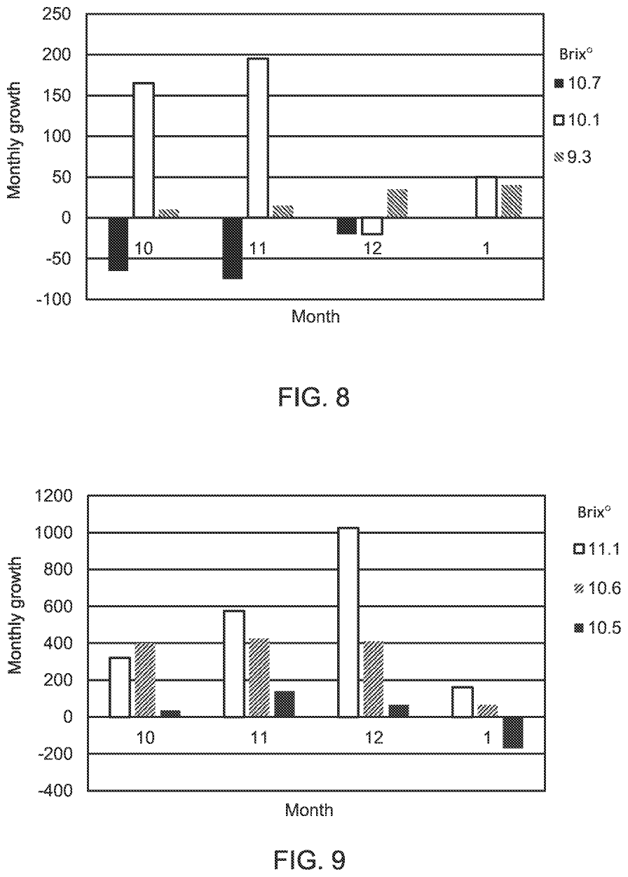

Trunk growth of 6 samples of Candy Princess peach trees and 6 samples of Polar Princess peach trees in plots in Victoria, Australia was monitored in accordance with some embodiments of the present invention. Brix level of fruits of specific monitored trees was measured using portable refractometer (Atago, Japan). The results are shown in FIGS. 8 and 9, respectively, which show the monthly growth in microns. The growth of was negatively correlated to the brix level during the month of December for the Candy Princess peaches (FIG. 8) and during the month of January for the Polar Princess peaches (FIG. 9). This difference may be attributed to the difference in fruit development, corresponding to the harvest date.

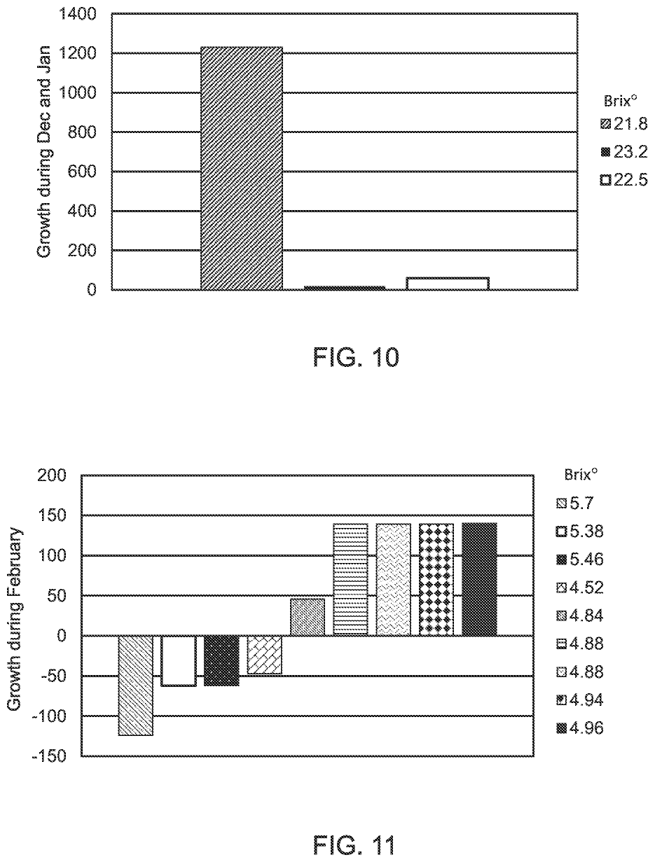

Trunk growth of 6 samples of prune orchid trees in New South Wales, Australia was monitored in accordance with some embodiments of the present invention. Brix level of fruits of specific monitored trees was measured using portable refractometer (Atago, Japan). FIG. 10 shows the additive growth during December and January. As shown there is a high additive growth (about 1200 μm) resulted in lower brix level and lower high additive growth (less than 100 μm) resulted in higher brix level.

### Example 4

### Tomatoes

Trunk growth of 6 samples of open field tomato plants in two different regions in Victoria, Australia was monitored in accordance with some embodiments of the present invention. Brix level of fruits of specific monitored plants was measured using portable refractometer (Atago, Japan). FIG. 11 shows the monthly growth during February. As shown, there is a negative correlation between the growth and the brix level. All plants that exhibited shrinkage in diameter (negative growth) resulted in brix level of more than 4.5° Bx, and all plants that exhibited a positive growth resulted in brix level of less than 4.5° Bx.

The results of the experiments described in the above Examples demonstrate that by monitoring the growth of the plant the quality of the fruit can be predicted, and further demonstrate that by restricting the growth when the monitored growth exceeds a preselected threshold an improved fruit quality, particularly an improved sugar accumulation, can be obtained.

### Example 5

### Pears

Trunk growth of 133 different trees in commercial plots in Victoria, Australia was monitored in accordance with some embodiments of the present invention. Brix measurements were obtained by hand sampling of fruits within 5 days from harvest.

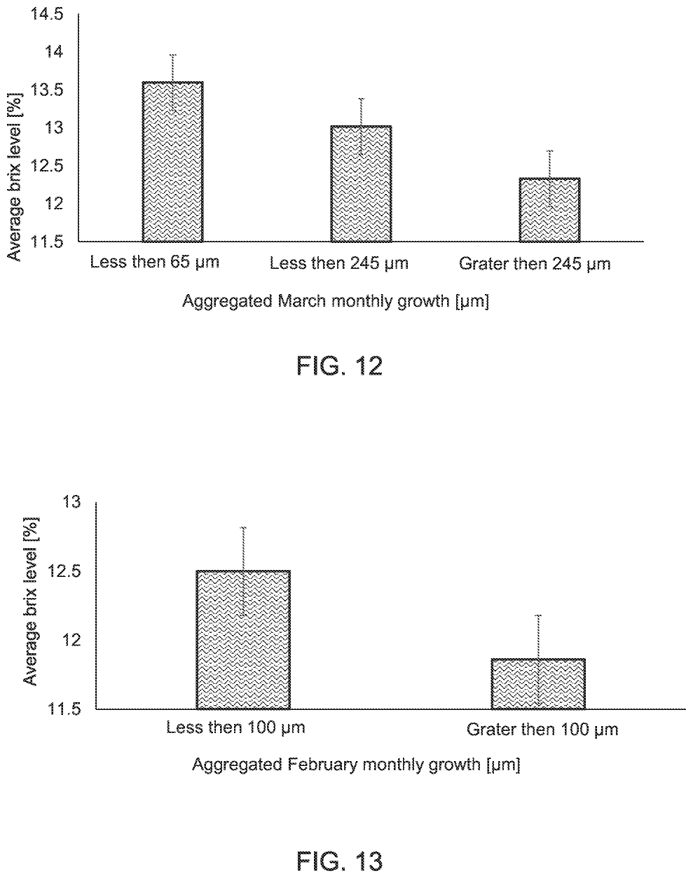

FIG. 12 present the average of measured Brix level (10 samples per tree) as a function of aggregated trunk growth during the month of March (approaching fruit ripe). As shown, the highest brix level is achieved at a minimal growth value, achieving higher Brix levels in over 1% in average. This process is in parallel to the sugar accumulation in the fruit.

### Example 6

### Apples

Trunk growth of 152 apple trees (60 Gala apples, and 92 Pink Lady apples) in commercial plots in Victoria, Australia was monitored in accordance with some embodiments of the present invention. Brix level measurements were obtained by hand sampling of fruits within 5 days from harvest.

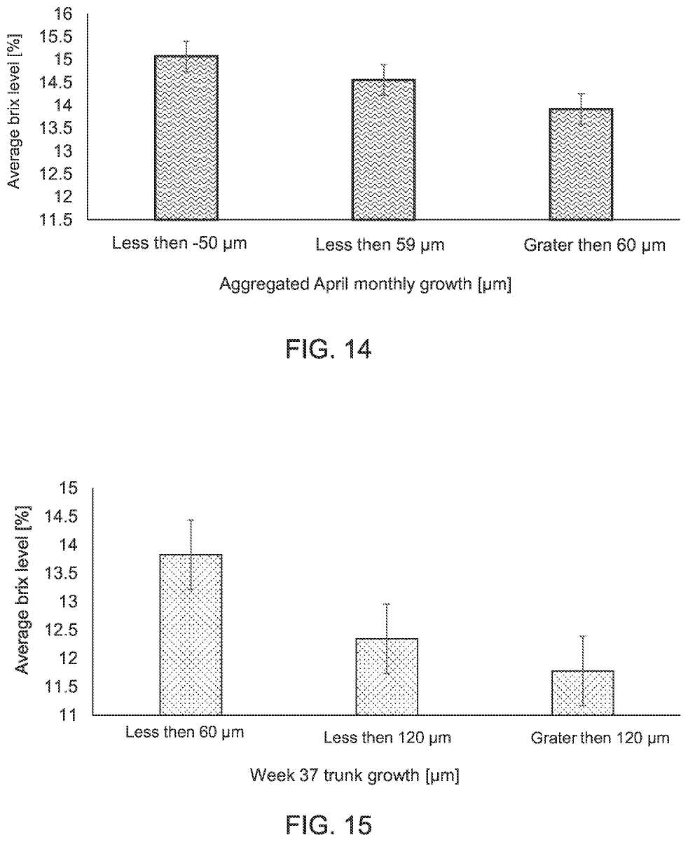

FIGS. 13 and 14 present the Brix level as a function of monthly trunk growth. Brix level in both cases was negatively correlated to the trunk growth. Different Brix level dependence on trunk growth were observed at different months with respect to picking date. The Gala apples were picked around March and the Pink Lady apples were picked two months later. Gala apples trees achieved low trunk growth in February (less than 100 microns) presented Brix average higher in about 0.5% than other trees (FIG. 13). For the Pink Lady apples, Brix levels was over 1% higher for trees which achieved less than-50 microns of trunk growth in April, compared to ones with over 60 microns (FIG. 14).

### Example 7

### Clementine Mandarins

The trunk growth of 41 clementine mandarin trees were monitored at commercial plots in California USA over the course of 2020 season. Brix measurements were obtained by hand sampling of fruits within 15 days from harvest. FIG. 15 presents the average Brix level as a function of trunk growth occurred in the second week of September. As shown, at this specific week, trees achieved growth below 60 microns had Brix levels at 2% higher on average, compared to trees with trunk growth over 120 microns.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

### REFERENCES

[1] Agustí, M., Martinez-Fuentes, A., & Mesejo, C. (2002). Citrus fruit quality. Physiological basis and techniques of improvement. Agrociencia, 6(2), 1-16.
[2] Ballester, C., Intrigliolo, D., National, S., & Castel, J. R. (2013). Response of Navel Lane Late citrus trees to regulated deficit irrigation: Yield components and fruit composition Response of Navel Lane Late citrus trees to regulated deficit irrigation: yield components and fruit composition. (January 2014). wwwdoi(dot)org/10.1007/s00271-011-0311-3
[3] Castel, J. R. (2015). Regulated deficit irrigation in ‘Clementina de Nules’ citrus tree: Effects on vegetative growth. (July 2000). wwwdoi(dot)org/10.5424/sjar/2003012-25
[4] Dichio, B., Xiloyannis, C., Sofo, A., & Montanaro, G. (2007). Effects of post-harvest regulated deficit irrigation on carbohydrate and nitrogen partitioning, yield quality and vegetative growth of peach trees. Plant and Soil, 290(1-2), 127-137. wwwdoi(dot)org/10.1007/s11104-006-9144-x
[5] Garc, I., Romero, F., Muriel, J. L., & Capote, N. (2012). Towards the Improvement of Fruit-Quality Parameters in Citrus under Deficit Irrigation Strategies. ISRN Agronomy, 2012. wwwdoi(dot)org/10.5402/2012/940896
[6] GI Moss, M. H. (1974). Magnesium influences on the fruit quality of sweet orange (Citrus sinensis L. osbeck). Plant and Soil, 112, 103-104.
[7] Goldschmidt, E. E. (1999). Carbohydrate supply as a critical factor for citrus fruit development and productivity. HortScience, 34(6), 1020-1024. wwwdoi(dot)org/10.21273/hortsci.34.6.1020
[8] Grattan, S. R., & May, D. M. (1991). Tomato Fruit Yields and Quality under Water Deficit and Salinity. 116(2), 215-221.
[9] Mccarthy, M. G., Cirami, R. M., & Mccloud, P. (2017). Vine and Fruit Responses to Supplementary Irrigation and Canopy Management. South African Journal of Enology & Viticulture, 4(2). wwwdoi(dot)org/10.21548/4-2-2372
[10] Mustafa, S. (2017). Effects of different citrus rootstocks on growth, yield, quality and granulation of ‘Hamlin’ orange in Oman Effects of Different Citrus Rootstocks on Growth, Yield, Quality and Granulation of ‘Hamlin’ Orange in Oman. (August 2011). wwwdoi(dot)org/10.17660/ActaHortic.2011.903.78
[11] Serman, F. V., Liotta, M., & Parera, C. (2004). Effects of Irrigation Deficit on Table Grape cv. Superior Seedless Production. Acta Horticulturae, (September 2016). wwwdoi(dot)org/10.17660/ActaHortic.2004.646.23
[12] Tejero, I. G., Hugo, V., Zuazo, D., Antonio, J., Bocanegra, J., Luis, J., & Fernandez, M. (2011). Scientia Horticulturae Improved water-use efficiency by deficit-irrigation programmes: Implications for saving water in citrus orchards. Scientia Horticulturae, 128, 274-282. wwwdoi(dot)org/10.1016/j.scienta.2011.01.035

1. A method of predicting fruit quality in a crop before harvesting said crop, the method comprising:
receiving a fruit quality threshold for the crop;
selecting a sub-seasonal time-window and a growth threshold, based on said fruit quality threshold;
monitoring growth of the crop before a beginning of said time-window, and continuing said monitoring throughout said time-window;
if said monitored growth is below said growth threshold during at least 80% of said time-window, then predicting a fruit quality which is above said fruit quality threshold for at least a first percentage of the crop.

2. The method according to claim 1, comprising restraining a growth of said crop if said monitored growth is not below said growth threshold.

3. The method according to claim 2, comprising terminating said restraining of said growth of said crop when said monitored growth is below said growth threshold.

4. The method according to claim 3, wherein if said restraining of said growth of said crop is within said time-window, then predicting a fruit quality which is above than said fruit quality threshold for at most a second predetermined percentage of the crop, said second percentage being not higher than said first percentage.

5. The method according to claim 2, wherein said restraining said growth comprises reducing or terminating irrigation.

6. The method according to claim 2, wherein said restraining said growth comprises reducing or terminating fertilization.

7. (canceled)

8. The method according to claim 1, wherein said monitoring said growth comprises monitoring a width of a trunk of a fruit tree.

9. (canceled)

10. The method according to claim 1, wherein the fruit quality comprises level of total soluble solids.

11. (canceled)

12. The method according to claim 1, wherein the crop is a citrus crop.

13. (canceled)

14. The method according to claim 1, wherein the crop is a stone fruit crop.

15. (canceled)

16. The method according to claim 1, wherein the crop is a grape crop.

17. (canceled)

18. The method according to claim 1, wherein the crop is a tomato crop.

19. (canceled)

20. The method according to claim 1, wherein the crop is a pear crop.

21. (canceled)

22. The method according to claim 1, wherein the crop is an apple crop.

23. (canceled)

24. The method according to claim 10, wherein the crop is a citrus crop.

25. (canceled)

26. The method according to claim 24, wherein said fruit quality threshold equals at least 10° Bx, and said first percentage equals at least 50%.

27. (canceled)

28. The method according to claim 1, wherein a duration of said time-window is at least one month but less than three months.

29. (canceled)

30. A computer software product, comprising a non-transitory computer-readable medium in which program instructions are stored, which instructions, when read by a data processor, cause the data processor to receive receiving a sub-seasonal time-window, a growth threshold, a fruit quality threshold, and monitored values of growth of a crop before a beginning of said time-window, and the execute the method according to claim 1.

31. A system for predicting fruit quality in a crop before harvesting said crop, the system comprising:
a sensor system deployed and configured for measuring and transmitting data pertaining to a growth the crop; and
a data processor configured for receiving a fruit quality threshold for the crop, for selecting a sub-seasonal time-window and a growth threshold, based on said fruit quality threshold, and for predicting a fruit quality which is above said fruit quality threshold for at least a first percentage of the crop if said monitored growth is below said growth threshold during at least 80% of said time-window.

32. The system according to claim 31, wherein said data processor is configured for generating output instructing to restrain a growth of said crop if said monitored growth is not below said growth threshold.

33. The system according to claim 32, wherein said data processor is configured for generating output instructing to terminate said restraining of said growth of said crop when said monitored growth is below said growth threshold.

34-40. (canceled)
